(19) United States
(12) Patent Application Publication
(10) Pub. No.: US 2008/0040418 A1
(43) Pub. Date: Feb. 14, 2008

(54) ACCESSING EXISTING DATA USING A SERVICE ORIENTED ARCHITECTURE GATEWAY

(75) Inventor: John Power, Dublin (IE)

Correspondence Address: SEYFARTH SHAW LLP, WORLD TRADE CENTER EAST, TWO SEAPORT LANE, SUITE 300, BOSTON, MA, 02210-2028, US

(73) Assignee: Risaris, Co Wicklow (IE)

(21) Appl. No.: 11/837,629

(22) Filed: Aug. 13, 2007

Related U.S. Application Data
(60) Provisional application No. 60/837,391, filed on Aug. 11, 2006.

(51) Int. Cl. G06F 15/16; G06F 17/30; H04L 9/32

(52) U.S. Cl. 709/202; 707/10; 726/3; 707/E17.005

(57) ABSTRACT

A Service Oriented Architecture [SOA] gateway is provided which exposes existing databases and business logic as basic W3C based web services. The SOA gateway enables databases and business logic on existing platforms to be accessed easily by known technologies. The SOA gateway runs on existing platforms where critical data and business logic resides. This enables direct access to the data and business logic without the need for additional middleware. Such single tier implementations have fewer points of failure and are thus more reliable than alternative methods. The SOA gateway authenticates users who access data and business logic and utilize the users' own a security context on the existing platform.

### CROSS REFERENCE TO RELATED APPLICATIONS

This application claims priority to U.S. Provisional Patent Application No. 60/837,391 filed on Aug. 11, 2006 which is incorporated herein by reference in its entirety.

### FIELD OF THE INVENTION

The present invention relates to computer database platforms, and more particularly to accessing existing database and business logic platforms as basic web services.

### BACKGROUND OF THE INVENTION

Existing database and business logic platforms have been at the core of medium to large businesses for the last 30 years or more. Attempts to move away from some of these existing platforms in the past have failed in most cases due to the cost of reengineering, application testing and the cost of reworking all the processes around these platforms. In some cases, data was replicated to other platforms where the data was easier to access from the newer technologies. However, such data replication is not always optimal because the data to be replicated may not be up to date. Further, such replication drastically increases the cost of maintaining data. For these reasons, businesses continue to use exiting database and business logic platforms that may be otherwise obsolete.

Due to divergent standards and access methods, it has heretofore been impossible to provide online transaction processing (OLTP) level access to data and business logic on many existing database and business logic platforms. These platforms host business critical IT assets for an organization. These IT assets are in the form of data in various databases or business logic in the form of tried and tested application programs that are in constant use.

Traditionally the design of new web service applications which must access data within an existing platform involves separate development of multiple elements and levels. FIG. 1 is a system diagram illustrating a traditional system for integrating new applications with existing database and business logic platforms. In order to access existing data 102 or business logic on an existing system, a new application 104 has typically been designed to communicate with a client-side proprietary software interface 106, which in turn communicates with client-side middleware technology 108. The client side middleware technology 108 has typically been designed to communicate with server-side middleware technology 110 which in turn communicates with a proprietary software server 112 to access the existing data 102.

Each of the elements of such traditional design strategies, which are shown as boxes in FIG. 1, represent additional system costs. Such costs include, the cost of developing the element's functionality, the cost of integrating the elements with each other and the cost of maintaining the resulting system. Furthermore, each element adds a potential point of failure and substantially increases the possibility of system failure and increases the cost of testing each part of the system.

### SUMMARY OF THE INVENTION

The present invention provides Service Oriented Architecture (SOA) systems and methods which can resolve many of the difficulties with enterprise integration. At the core of these the inventive technologies are standards based web services such as World Wide Web Consortium (“W3C”) based web services which can expose their data and business logic including core IT assets. Such technologies can provide an interface that will enable the core IT assets of an enterprise to fit seamlessly into an SOA infrastructure.

Embodiments of the present invention provide a system and method for integrating new applications with data and business logic on existing platforms. The inventive integration strategy reduces the complexity, risk and cost involved compared to traditional integration strategies. Embodiments of the invention allow developers to focus on the development of new applications rather than developing an infrastructure for accessing existing data sources.

Embodiments of the present invention provide an SOA gateway which exposes existing databases and business logic as basic W3C based web services. This enables the databases and business logic on existing platforms to be accessed easily by technologies such as Microsoft .net framework, IBM's Web Sphere, BEA's Web Logic, Microsoft's Biz Talk 2004 and many others. This can significantly reduce the cost and complexity of using existing IT assets in enterprise integration projects by providing the basic data and business logic building blocks to integrate systems and automate business processes.

Embodiments of the present invention run on the existing platforms where the data and business logic resides. This enables direct access to the data and business logic without the need for additional middleware. Such single tier implementations of the present invention have fewer points of failure and are thus more reliable than alternative methods. Further, the embodiments provide improved reliability because they utilize tried and proven technologies.

Embodiments of the invention provide security by authenticating users who access data and business logic and by utilizing the users' own security context on the existing platform. As such, the embodiments interface seamlessly with existing security definitions on these platforms. Embodiments of the present invention are based on open standards, and written in well known programming languages such as C and C++ to provide portability. Therefore, they can be run on many existing platforms to expose any data or business logic on these platforms as a standards based web service.

An illustrative embodiment of the invention implements formally agreed W3C standards thus ensuring interoperability with other systems which use these standards. The W3C standards committee defines the standards on which the Internet was built.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1 is a system diagram illustrating a traditional system for integrating new applications with existing database and business logic platforms according to the PRIOR ART;

FIG. 2 is a system diagram illustrating a system for integrating new applications with existing database and business logic platforms according to illustrative embodiments of the invention;

FIG. 3 is a system block diagram showing an implementation of an SOA gateway according to an illustrative embodiment of the invention;

FIG. 4 is a system diagram showing how a WSDL for a database file or existing program can be obtained according to an illustrative embodiment of the invention;

FIG. 5 is a system diagram showing how a database operation can be executed in response to obtaining the WSDL according to an illustrative embodiment of the invention;

FIG. 6 is a system diagram showing how a 3GL or 4GL program containing business logic can be invoked in response to obtaining the WSDL according to an illustrative embodiment of the invention; and

FIG. 7 is a process flow diagram for accessing an existing IT asset according to an illustrative embodiment of the invention.

### DETAILED DESCRIPTION

Web Services are based primarily around two agreed standards. The Web Service Definition Language or WSDL standard enables a web service to tell a web services consumer how to use the services it offers. The Simple Object Access Protocol or SOAP provides the protocol by which each of the services being offered may be invoked. According to illustrative embodiments of the present invention, an inventive SOA Gateway uses these technologies to expose existing databases and business logic as standards based web services.

The inventive SOA Gateway exposes data and business logic such as core IT assets on existing platforms as web services. This means that consumers of Web Services such as Microsoft .net applications, Web Sphere, Web Logic and the like, can request the Web Service Definition Language (WSDL) for the service exposing the data they want. The WSDL contains information to enable the Web Services consumer to call the services available to access the existing data or business logic including the core IT assets of an organization.

This integration takes place through a straight forward configuration process with no coding required on the platform where the core IT assets reside. In this way, the product enables .net applications, Web Sphere, Web Logic and other Web Services consumers to easily access the business data and business logic on existing platforms.

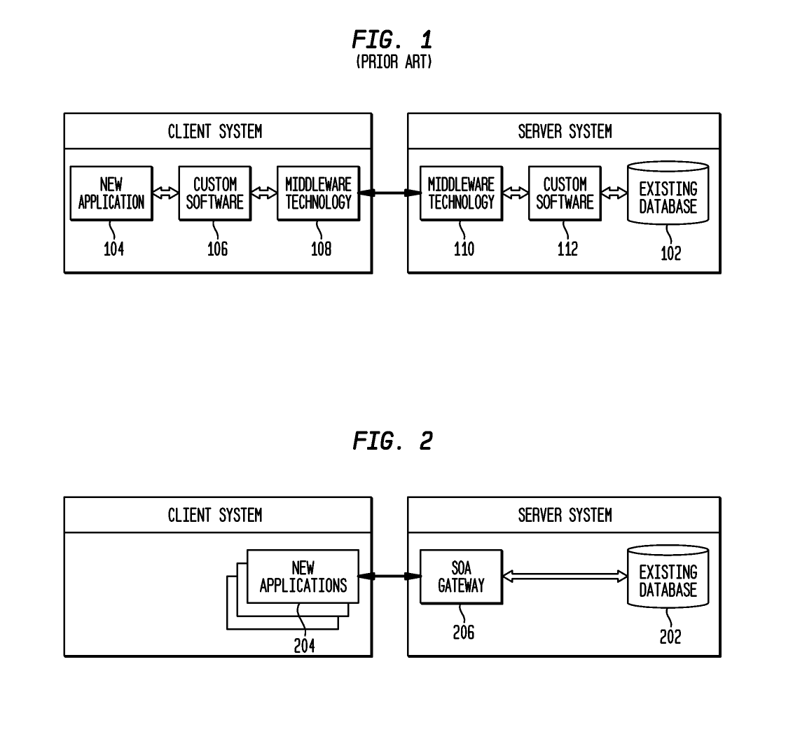

FIG. 2 illustrates a system for integrating new applications with existing database and business logic platforms according to illustrative embodiments of the invention. In order to access existing databases or business logic 202, new applications 204 can be designed with standards based web service interfaces to communicate with an SOA gateway 206 on the existing platform and configured according to the invention. The SOA gateway 206 exposes the existing data and business logic 202 as a web service to the new application 204. The embodiments thereby eliminate the need to develop, integrate and maintain a client side proprietary interface 106 (FIG. 1), client side and server side middleware technologies 108, 110 (FIG. 1) and software server 112 (FIG. 1).

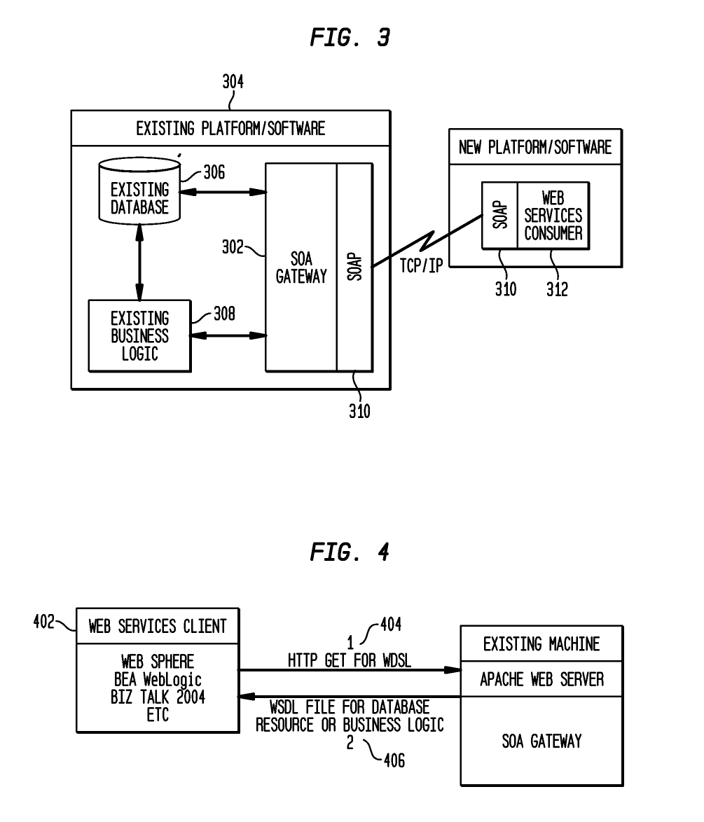

According to illustrative embodiments of the invention, existing data and business logic including core IT assets can seamlessly integrate with the Enterprise Services Bus (ESB) of an existing platform and can make these assets available in a standard way. FIG. 3 is a system block diagram which illustrates this concept.

Referring to FIG. 3, the SOA Gateway 302 according to the invention is installed locally on the platform 304 listing core IT assets including existing databases 306 and existing business logic 308. Access to the services is provided using the protocols 310 that define what a Web Service is. The Web Services consumer 312 learns what interfaces it can call by requesting the WSDL for the resource to be accessed from the SOA Gateway 302. It learns from this what requests it can make against the IT asset. Typically when communicating with a database, it is possible to list, add, delete, get and update the data on the database. When accessing business logic, a single process such as an “sg-invoke” enables C, Natural, COBOL, PL/1 and even assembler programs to be invoked.

The delivery of WSDL and SOAP messages occurs over the hypertext transfer protocol [HTTP] and can therefore be secured using the well known Secure Sockets Layer [SSL] protocol. The SOA Gateway runs within the Apache Web Server where it is possible to install the Apache SSL module to secure access to the server. The SOA Gateway implementation of Apache SSL interfaces with the local security system and allocates a local security context to the unit of work. On the well known z/OS operating system for example, an SSL certificate is provided to a resource allocation control facility [RACF] which allocates a RACF user context. The SSL Certificate is defined to RACF and allowed to use the services. The request then runs with this security context until completion. Thus all data or business logic access will run using the security credential of the original user accessing the service.

The SOA Gateway enables a number of resources on a platform to be updated within the context of the same transaction. The SOA Gateway ensures that updates that occur from the invocation of business logic or the updating of one or more databases retains the ACID transaction properties (Atomicity, Consistency, Independence and Durability) by interfacing with the local transaction manager to manage the transaction. For example, on the z/OS operating system, the SOA Gateway interfaces with the Resource Recovery Management Service [RRMS] of the operating system, whereas on Open Systems platforms, the SOA Gateway can interface with the well known “Tuxedo” transaction processing monitor.

The inventive SOA Gateway performs at OnLine Transaction Processing (OLTP) levels that are consistently delivered by existing platforms. Embodiments of the SOA Gateway are primarily built around well proven existing technologies including Apache, Apache SSL and Xerces. Illustrative embodiments of the SOA Gateway utilize the well known Apache Web Server as a base run time environment because Apache Web Server can handle large numbers of requests per second as expected of an OLTP ready system. In addition, the SOA Gateway runs locally to the data and business logic that it exposes and makes the data and business logic available directly using TCP/IP without any additional middleware requirement. This means that there are fewer points of failure and this leads to a more reliable Web Services structure.

By running locally on the same platform as the data and business logic, the SOA Gateway has the ability to work more closely with the local platform infrastructure. This leads to better integration from a security perspective, better integration in the area of transactionality and better performance as the data is exposed at the earliest possible point as a Web Service. The SOA gateway can also interface directly with local resources such as dispatching mechanisms, performance monitors and the like. The inventive system allows all of the data for measuring performance and identifying problems to reside in one place. Thus, performance is more easily measured and problems are more easily managed because there is only one layer and one platform to check when problems occur.

The SOA Gateway is focussed on providing data using Web Services such as W3C standard compliant web services and can be optimised based on the W3C protocol standard. This ensures that SOA Gateway will interoperate seamlessly with other software that is compliant with the W3C protocol standards. In addition, from a strategic perspective the SOAP protocol is the basis upon which new infrastructure is being built. This will leave users of the SOA Gateway according to the invention ready for the next generation of infrastructure by fitting into the contemporary infrastructure seamlessly.

The SOA Gateway has been designed as a portable and structured technology. The main core of the SOA Gateway is C and C++. Accordingly, the core of the inventive SOA Gateway can be ported to most existing database and/or business logic platforms. Database and language interfaces of the SOA Gateway, which function as described hereinafter, are built as Data Source Driver plug-ins and can support well known databases like ADABAS, VSAM, DB2, IMS/DB and business logic written in well known languages such as Natural, COBOL, PL/1 and assembler.

Embodiments of the present invention expose standard application programming interfaces [APIs] for similar resources. Generally, most databases have similar interfaces through which data can be accessed. Therefore, it is often possible to use the same code to access different data sources. Illustrative embodiments of the present invention map directly from extended mark-up language [XML] to the data format expected from the data source and back to XML. This is in contrast to other systems and methods which map to internal programming constructs or to SQL and then to the back end data.

The present invention generates the WSDL containing the interfaces dynamically based on configuration information entered once rather than using statically generated WSDL files.

The present invention provides standard interfaces described with WSDL to configure the server thereby enabling users to write their own interfaces. Further, the present invention provides standard interfaces described with WSDL to retrieve statistical information from the server which enables users to write their own clients.

The present invention takes advantage of the Simple Object Access Protocol or SOAP, which has emerged as a mechanism to enable applications to access objects on virtually any platform without specific knowledge of the platform. Together, WSDL and SOAP form the basis for the provision of Web Services. SOAP has been accepted as the best protocol available for accessing data and applications on heterogeneous platforms without any knowledge of the platform or the operating system where the accessed object resides. SOAP is also emerging as the agreed standard for future application development and integration efforts.

The inventive SOA Gateway allows data and business logic to be exposed in a simple, open and logical fashion that requires no coding on the platform where the data and business logic resides. This allows access to existing data and business logic on existing platforms simply by installing software and configuring it. This task can typically be undertaken by system administrators who are typically available on site. Later projects can reuse the software with only minor configuration changes to make additional data available for other application development or integration projects.

The present invention has few points of failure because the application communicates directly to the software that accesses the database or the program containing the business logic. Thus an additional layer from client to middleware and middle ware to server is avoided. Fewer points of failure provide a more stable and reliable implementation. The illustrative embodiments of the present invention allow for less software to be installed on the existing system and requires fewer layers communication between a web service consumer and IT assets. This leads to a smaller footprint on a system and less usage of valuable memory and CPU resources.

Once the SOA Gateway has been installed on a platform, the only additional efforts that must be made to make data or business logic available is to configure the SOA Gateway to access the table, file or other resource in a database, or to access the program containing the business logic. This can be done by an administrator or systems programmer for the existing platform. It is not necessary to employ programmers with the appropriate knowledge to develop code on that platform. No knowledge of different platforms and/or software is required to implement the present invention apart from that which will be used for the new application or integration effort. This facilitates less complex project development or implementation because programmers are working in the same environment and no coordination is required with programmers on different platforms.

The inventive SOA Gateway provides a specialized service to access data and business logic and does only what is required for a particular implementation. Once a resource has been exposed it can be reused by further application development or integration projects. No further configuration or programming is required as the resource is available in a standard fashion. When the system is implemented, continuing support is only required for the new code on the platform where it has been installed. Once programmers have learned to manipulate one database resource with the SOA Gateway Web Services requests, any database supported by the SOA Gateway can be accessed using the same technique. This saves on training and enables programmers to be more productive.

The inventive SOA Gateway allows a standard Web Service to expose existing data and business logic to the next generation of applications. The SOA Gateway publishes services that are available for the existing data and business logic that it exposes using the WSDL. This publication is an XML format document which describes the list of functions that the Web Service implements, the input message that each function accepts and what it will return as output. These WSDL documents are understood by the Web Services consumer which can thus learn how to invoke the functions without any code or footprint on the Web Services consumer platform.

FIG. 4 illustrates how the WSDL for a database file or existing program can be obtained. First, the Web Services client 402 requests 404 the WSDL for the database resource or program containing the business logic that the client 402 wishes to access. The WSDL file is returned 406 providing the web services client 402 with the possible operations available, e.g. list, get, add, delete, etc. for a database resource or process for a program containing business logic.

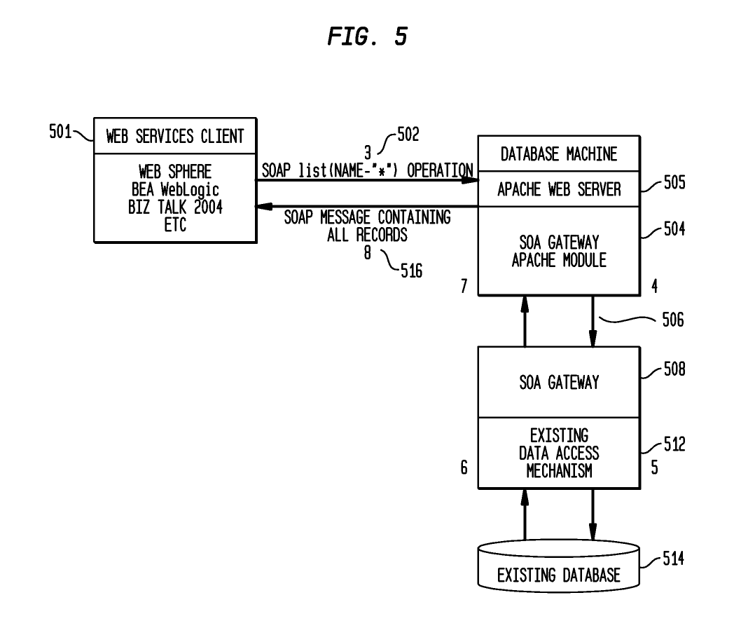

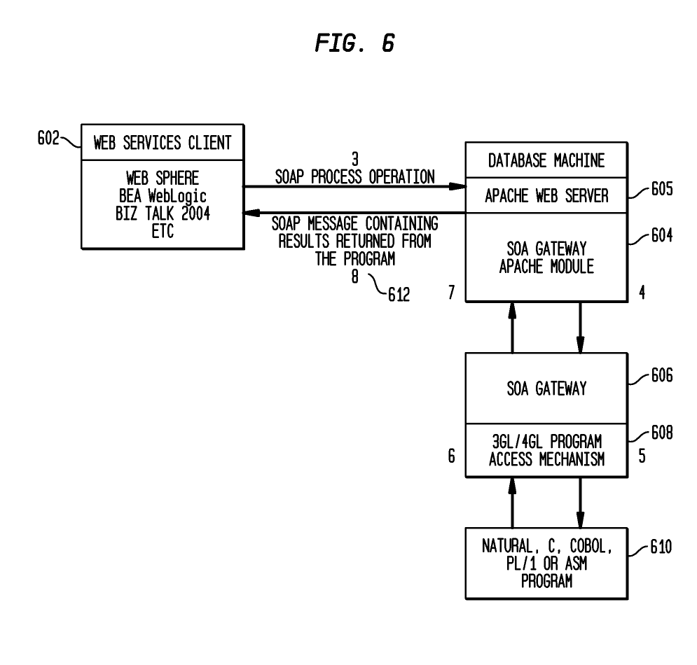

Referring to FIG. 5, further functionality of the SOA Gateway according to the invention is illustrated. After getting the WSDL, the web service client 501 selects 502 which operation they wish to execute. For example, a ‘list’ function can be chosen which will return an XML document containing 0 or more records or rows from the file or table in the database for which the provided key data matches. The web service client software knows what keys are available because this information was provided to it in the WSDL. An SOA Gateway Apache module 504 running on an Apache Web Server 505 handles this request and passes 506 the required info to an SOA Gateway engine 508. The SOA Gateway engine 508 operates to pass information to an independent data access module 512 which issues proprietary access calls against the existing database 514. The data access module 512 communicates to the database 514 and returns the data to the SOA Gateway engine 508. The results are constructed into a SOAP response by the SOA Gateway engine 508. Results are returned 516 to the web service client 501 in a standard SOAP response. The client software knows the format of this response as it will have been published in the WSDL.

The SOA Gateway can extract whatever data it needs from definitions already in place if there are any. For example, with the well known ADABAS database, a data dictionary is available in the Predict database. Where there is no data dictionary, all information can be defined to the SOA Gateway directly.

FIG. 6 illustrates a process according to an illustrative embodiment of the invention for invoking a 3GL or 4GL program (i.e. written in a third generation or fourth generation high level programming language) containing business logic. After receiving the WSDL, the web service client 602 selects which operation to execute. To invoke a program containing business logic, a ‘process’ function is used. A message to this function contains whatever elements the program expects as input for its processing. The SOA Gateway Apache module 604 running on an Apache Web Server 605, for example, handles this request and passes the required info to the SOA Gateway engine 606. The SOA Gateway engine 606 parses the request from its XML format into the format required for the program being called. A 3GL/4GL driver mechanism 608 calls the Natural, C, COBOL, PL/1 or ASM program 610 with the parameters provided by the SOA Gateway engine 606 and returns the results of the program call to the SOA Gateway engine 606. The results are constructed into a SOAP response 612 by the SOA Gateway engine 606 and returned to the client 602. The web service client software knows the format of this response as it will have been published in the WSDL.

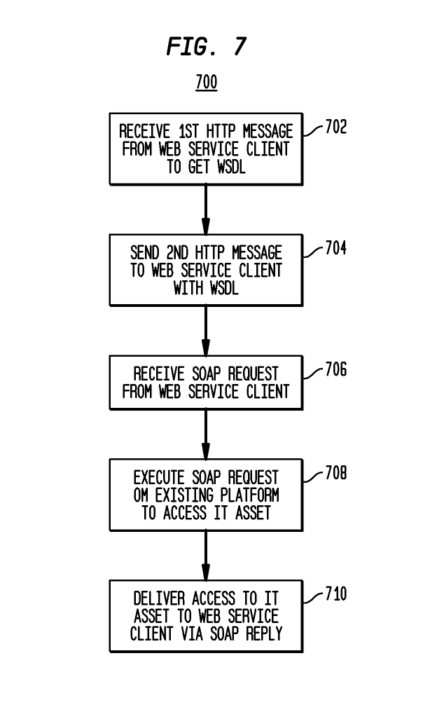

FIG. 7 is a process flow diagram for accessing an existing IT asset according to the illustrative embodiments of the invention. A service oriented architecture (SOA) gateway is installed on a platform containing the existing IT assets. The existing assets are exposed through the gateway as web services to web service clients. Initially, 702, a first message is received from a client requesting a web service definition language (WSDL) corresponding to the asset. Once the client requests the WSDL, in a second step 704, a second message is sent to the client identifying the WSDL in response to the first message. After the WSDL is identified, in a third step 706, a third message is received from the client including a simple object access protocol (SOAP) call corresponding to the identified WSDL. In a fourth step 708, the SOAP call is executed on the existing platform to access an IT asset. In a fifth step 710, a fourth message is sent to the client responsive to the SOAP call in response to the third message.

Embodiments of the present invention enable existing data to fit into the new frameworks that are SOA based. By providing a Web Services Interface to existing data and business logic, integration occurs automatically using configuration tools. This removes the requirement to write specialised code for accessing data. In other words, the existing data becomes a ‘plug in’ rather than something that requires a large development effort to fit into a particular framework.

The inventive SOA Gateway can be integrated with BEA Web Logic platforms wherein a BEA Web Logic platform pulls in the WSDL from the SOA Gateway service. Web Logic then enables the application programmer to generate various objects such as Web Logic Service Controls and JPD files from the WSDL interface. These objects can then be used naturally by the Web Logic programmer without any knowledge of the structure of the existing database or language of the business logic. All existing data to be accessed can simply be included in the same way. The integration steps can be made once the programmer knows where the SOA Gateway server resides.

Embodiments of the SOA Gateway can be integrated with IBM's Web Sphere whereby the Web Sphere platform enables the programmer to integrate the WSDL from the inventive SOA Gateway service into the current work space. Web Sphere then enables the programmer to generate Enterprise Java Bean Skeletons for access to the existing data. These Java Beans can then be used naturally by the Web Sphere programmer without any knowledge of the structure of the existing database or language of the business logic. The programmer can opt to use the Java Beans as they are or they can be modified with business logic if necessary. All of the integration steps can be made once the programmer knows where the SOA Gateway server resides.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention as set forth in the claims.

What is claimed is:

1. A method of accessing existing information technology (IT) assets comprising:
installing a service oriented architecture (SOA) gateway on a platform containing the existing IT assets; and
exposing the existing assets through the gateway as web services to web service clients.

2. The method of claim 1 wherein exposing the existing IT assets comprises:
providing online transaction processing (OLTP) access to the existing IT assets.

3. The method of claim 1 wherein the IT assets are exposed as W3C based web services.

4. The method of claim 1 wherein the IT assets are selected from the group consisting of databases and business logic.

5. The method of claim 1 wherein the IT assets comprise legacy databases and legacy business logic.

6. The method of claim 1 further comprising:
providing security by authenticating users with the users' pre-existing security context on the platform.

7. The method of claim 1 wherein the gateway complies with open standards programming techniques for portability.

8. The method of claim 1 wherein exposing the existing assets comprises:
receiving a first message from a client requesting a web service definition language (WSDL) corresponding to the asset;
sending a second message to the client identifying the WSDL in response to the first message;
receiving a third message from the client including a simple object access protocol (SOAP) call corresponding to the identified WSDL;
sending a fourth message to the client responsive to the SOAP call in response to the third message.

9. The method of claim 8 wherein the first message and the second message are hypertext transfer protocol (HTTP) messages.

10. A service oriented architecture gateway comprising:
a first interface for communicating with a web service client via HTTP messages and SOAP messages;
a second interface for communicating with existing IT assets;
means for processing HTTP messages and SOAP messages received from a client via the first interface to accesses the existing IT assets via the second interface; and
means for processing the existing IT assets to generate HTTP messages and SOAP messages representing the existing IT assets for communication to the web service client.

11. A system for accessing existing information technology (IT) assets comprising
a database machine having a web server and a service oriented architecture (SOA) gateway module installed thereon, the database machine adapted for communication with a web service client;
an SOA gateway in communication with the database machine via the SOA gateway access module, the SOA gateway having an existing data access mechanism installed thereon;
the existing data access mechanism adapted for communication with existing databases.

12. A system for accessing existing information technology (IT) assets comprising:
a database machine having a web server and a service oriented architecture (SOA) gateway module installed thereon, the database machine adapted for communication with a web service client;
an SOA gateway in communication with the database machine via the SOA gateway access module, the SOA gateway having an existing program access mechanism installed thereon; the existing program access mechanism adapted for communication with existing databases.

13. The system according to claim 12 wherein the SOA gateway further comprises an existing data access mechanism installed thereon, the existing data access mechanism being adapted for communication with existing databases.

14. A system for accessing existing information technology (IT) assets comprising:
means for installing a service oriented architecture (SOA) gateway on a platform containing the existing IT assets;
means for exposing the existing assets through the gateway as web services to web service clients;
means for providing online transaction processing (OLTP) access to the existing IT assets.

15. The system of claim 14 wherein the IT assets are exposed as W3C based web services.

16. The system of claim 14 wherein the IT assets are selected from the group consisting of databases and business logic.

17. The method of claim 14 wherein the IT assets comprise legacy databases and legacy business logic.

18. The system of claim 14 further comprising:
means for providing security by authenticating users with the users' pre-existing security context on the platform.

19. A computer readable media including computer readable instructions executable to provide access to existing IT assets by performing the steps of:
exposing the existing assets through the gateway as web services to web service clients; and
providing online transaction processing (OLTP) access to the existing IT assets.

20. The computer readable media of claim 19 including computer readable instructions executable to perform the further steps of:
receiving a first message from a client requesting a web service definition language (WSDL) corresponding to the asset;
sending a second message to the client identifying the WSDL in response to the first message;
receiving a third message from the client including a simple object access protocol (SOAP) call corresponding to the identified WSDL;
sending a fourth message to the client responsive to the SOAP call in response to the third message.
